(19) United States
(12) Patent Application Publication
(10) Pub. No.: US 2024/0028620 A1
(43) Pub. Date: Jan. 25, 2024

(54) SYSTEM AND METHOD FOR ENTITY RESOLUTION USING A SORTING ALGORITHM AND A SCORING ALGORITHM WITH A DYNAMIC THRESHOLDING

(71) Applicant: Dell Products L.P., Round Rock, TX (US)

(72) Inventors: Ismail Birkan Can, Limerick (IE); Samuel Kwonil Sone, Cedar Park, TX (US); Namrata Kripalani Felger, Austin, TX (US); Vishwanath Karthik Pendyala, Leander, TX (US)

(21) Appl. No.: 17/869,158

(22) Filed: Jul. 20, 2022

(51) Int. Cl. G06F 16/28; G06F 7/08; G06F 16/2455

(52) U.S. Cl. CPC G06F 16/287; G06F 7/08; G06F 16/24556

(57) ABSTRACT

A method for performing an entity resolution comprises obtaining, by an entity resolution manager, an aggregated database comprising a set of client information entries, in response to the obtaining: performing a sorting algorithm on attributes of each client information entry in the aggregated database to obtain a set of attribute groupings, performing a scoring algorithm on each of the set of attribute groupings to calculate a set of confidence scores each corresponding to a pair of attributes in each set of attribute groupings, assigning a group identifier (ID) to each item in each of the set of attribute groupings based on the set of confidence scores, performing a client resolution using the group ID of each item to obtain a graph-based attribute relation report, and display the graph-based attribute relation report on a graphical user interface (GUI).

### BACKGROUND

Computing devices in a system may be operated by clients. The clients may provide client information to one or more client environments. Each client environment may independently manage a client database. The client database may store entries associated with the clients.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart for performing entity resolution in accordance with one or more embodiments of the invention.

FIGS. 3A-3C show an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for managing client information. The system may include a number of client environments that each provide the client information to two or more client information collection systems. Each client information collection system may be an independent component. As such, each client information collection system stores client information independently from other client information. In one or more embodiments of the invention, the client information collection systems may each store entries that relate to a client (e.g., an entity). The entries may be provided to other components that request the client information.

For example, a first set of entries stored in a first client information collection system may be associated with a first client. A second client information collection system may collect a second set of entries. The second set of entries may be associated with the first client. The two sets of entries may include identical or substantially similar information. Despite this, the two independent client information collection systems may not associate the two sets of entries with the same client. For example, each of the set of entries may be associated with a unique identifier of a client.

Because the two independent client information collection systems do not associate client information with the same entity, other components obtaining the client information from the two client information collection system may not be initially aware of the association between the two sets of entries to the same entity. This issue may be more difficult to address when a large number (e.g., thousands) of entities are specified in the client information obtained from two or more independent client information collection systems.

Embodiments of the invention include a method for performing entity resolution for client information obtained from two or more client information collection systems that each operate and collect client information independently. Embodiments of the invention include an entity resolution manager that performs the entity resolution using a client information aggregation, a sorting algorithm, a scoring algorithm, and a grouping identifier assignment. These mechanisms are further discussed throughout this disclosure. The entity resolution may be presented (e.g., via a graphical user interface) to an administrator of the client information.

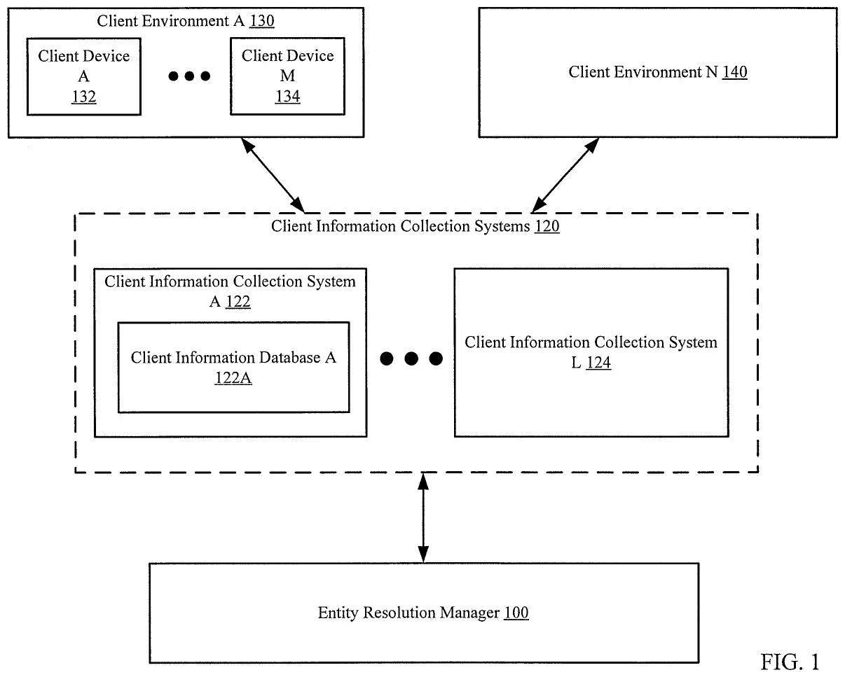

FIG. 1 shows an example system in accordance with one or more embodiments of the invention. The system includes an entity resolution manager (100), one or more client information collection systems (120), and any number of client environments (130, 140). The system may include additional, fewer, and/or different components without departing from the invention. Each component may be operably connected to any of the other components via any combination of wired and/or wireless connections. Each component illustrated in FIG. 1 is discussed below.

In one or more embodiments, the client environments (130, 140) include client devices (132, 134). Each of the client devices (132, 134) in a client environment (130) may be operatively connected to each other via any combination of wired and/or wireless connections. In one or more embodiments of the invention, each of the client environments (130, 140) may be independent from each other. Said another way, each of the client environments (130, 140) may perform any processes or services without any communication being performed between each other.

In one or more embodiments of the invention, each client device (132, 134) is operated by a user. Each user may be associated with any number of entities. In one or more embodiments, the entities may be defined by attributes by which the similarity is assessed. Examples of the attributes may include, but are not limited to: a name, an address, a company (e.g., that the user works for), a home phone number, and a work phone number. The users may utilize the respective client devices (132, 134) to provide client information to one or more client information collection systems (120). The client information may specify the aforementioned entities associated with the user.

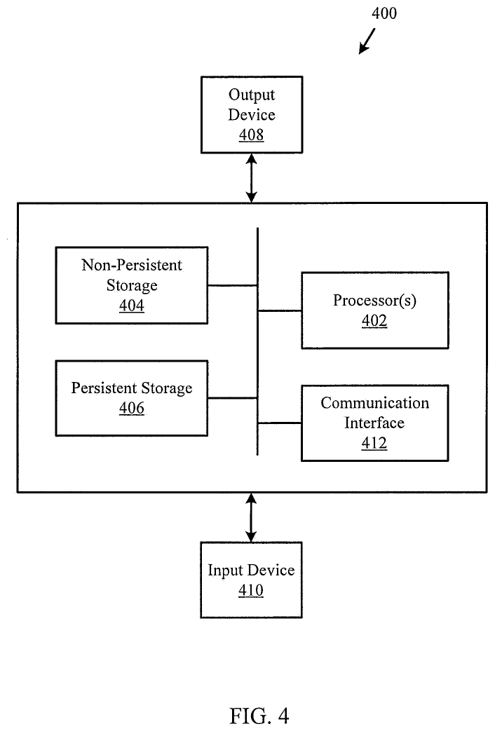

In one or more embodiments of the invention, each client device (132, 134) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client device (132, 134) described throughout this disclosure.

In one or more embodiments of the invention, each client environment (130, 140) is implemented as a logical device. The logical device may utilize the computing resources of any number of computing devices and thereby provide the functionality of the client environment (130, 140) described throughout this disclosure.

In one or more embodiments of the invention, the client information collection systems (120) obtain client information from the client environments (130, 140). The client information may be stored as client information entries in a client information database (122A). Each client information entry (also referred to as client entry) may include attributes associated with a user. The attributes may include, for example, a name of the user, an address, a company the user works for, a work number, and a home phone number. In one or more embodiments of the invention, each attribute is associated with an entity.

The client information collection systems (120) may operate independently of each other. Said another way, the client information collection systems (122, 124) may obtain client information from the client environments (130, 140) without any communication being performed between each other. Despite the lack of communication between each other, the client information collection systems (120) may collect similar or substantially similar client information.

In one or more embodiments of the invention, each client information collection system (122, 124) is implemented as a computing device (see e.g., FIG. 4). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client information collection system (122, 124) described throughout this disclosure.

In one or more embodiments of the invention, each client information collection system (122, 124) is implemented as a logical device. The logical device may utilize the computing resources of any number of computing devices and thereby provide the functionality of the client information collection system (122, 124) described throughout this disclosure.

In one or more embodiments, the entity resolution manager (100) includes functionality for performing entity resolution. In one or more embodiments, an entity resolution is a process for associating specified items for attributes (e.g., included in client information entries) to an entity based on a determination that the items of the attributes relate to the same entity. For example, a first client information entry obtained by a first client information collection system may specify an address with an item that has a value of “123 Main Street Apt. 101 New York, New York”. A second client information entry (e.g., obtained by a second client information collection system) may specify an address with an item that has a value of “123 main st. #101 New York, NY”. Though these two values do not contain the exact identical characters, the entity resolution manager (100) may perform the entity resolution discussed throughout this disclosure to determine that the two items describe the same entity.

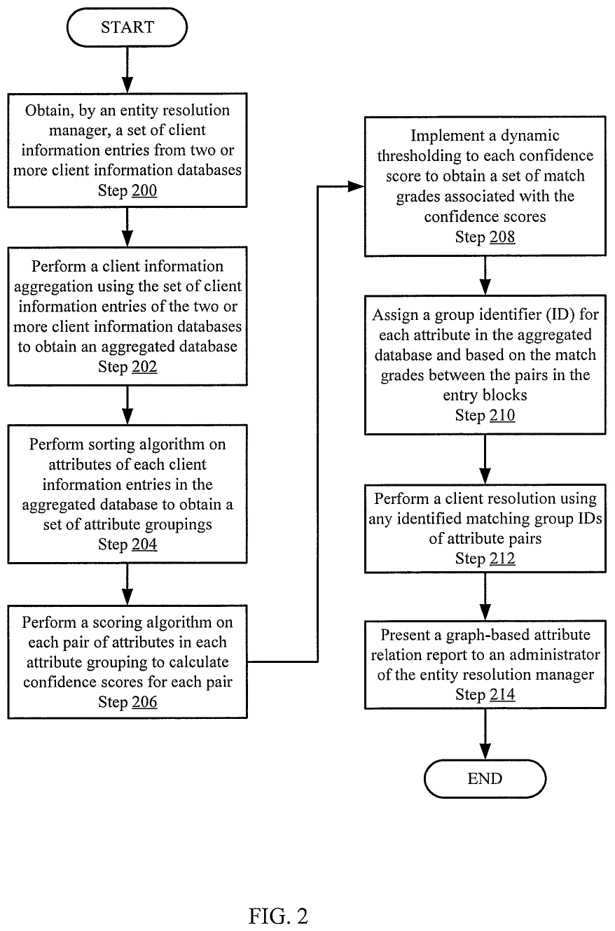

The entity resolution manager (100) may perform the entity resolution discussed, for example, in FIG. 2.

While the entity resolution manager (100) is illustrated in FIG. 1A as being a separate component, the entity resolution manager (100), and any components thereof, may be executed as part of one or more of the client information collection systems (120) and/or one of the client environments (130, 140) and/or any other components without departing from the invention.

FIG. 2 shows a flowchart for performing entity resolution in accordance with one or more embodiments of the invention. The method shown in FIG. 2 may be performed by, for example, an entity resolution manager (e.g., 100, FIG. 1). Other components of the system illustrated in FIG. 1 may perform the method of FIG. 2 without departing from the invention.

While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIG. 2 may be performed in parallel with any other steps shown in FIG. 2 without departing from the scope of the invention.

Turning to FIG. 2, in step 200, a set of client information entries are obtained from two or more client information databases. In one or more embodiments of the invention, the set of client information entries are collected from the client information collection systems. The set of client entries may be provided by the client information collection systems in response to requests sent by the entity resolution manager for the set of client information entries.

In step 202, a client information aggregation is performed using the set of client information entries of the two or more client information databases to obtain an aggregated database. In one or more embodiments of the invention, the client information aggregation includes generating the aggregated database and populating the aggregated database with the set of client information entries.

In step 204, a sorting algorithm is performed on attributes of each client information entries in the aggregated database to obtain a set of attribute groupings. In one or more embodiments of the invention, the sorting algorithm is a process for grouping the items of an attribute based on the values of the items. The sorting algorithm may include any combination of processing tasks for processing the values of each item for an attribute.

For example, a first processing task may include a sorted neighborhood indexing. In one or more embodiments, the sorted neighborhood indexing includes sorting the items based on the values of the items (e.g., alphabetically), and performing an initial grouping based on a pre-determined number. Performing the sorted neighborhood index results in generating an initial set of attribute groupings.

In one or more embodiments, a second processing task includes performing an n-gram blocking. The n-gram blocking includes setting a set of hyperparameters such as a number of grams to be considered and a threshold used to define the number of possible combinations. A gram may be a value used to define a maximum length of a portion of each item in the attribute. For example, an item may be defined as “peter”. For example, if a gram is assigned the value 2, each portion may be two characters long (e.g., “pe”, “et”, “te”, and “er”). The threshold may be used to determine the number of n-gram combinations to be used for processing. The threshold may be defined as a fraction of the total number of possible portions. In this example, if the threshold is 0.8, and the total number of portions that can be made with a n-gram of 2 is four, the number of portions per combinations is 3.2, which is rounded to three. In this example, a first n-gram combination may be {“pe”, “et”, “te”}.

In one or more embodiments of the invention, the n-gram indexing further includes performing a comparison of the combinations generated for each item to the combinations for each item for a given attribute. The items are grouped based on a percentage of combinations that match for each item. A pre-determined percentage is used to determine whether a pair of items are to be assigned to the same attribute grouping. The result of the n-gram indexing is a second set of attribute groupings.

In one or more embodiments, a third processing task includes performing an enhanced search. The enhanced search may include implementing a search and analytics engine (e.g., elastic search) to identify similarities between words in each item and performing a clustering algorithm based on the functionality of the search and analytics engine. The result of the clustering includes a third set of attribute groupings.

In one or more embodiments of the invention, the sorting algorithm includes a combination of any of the above-referenced processing tasks. For example, the sorting algorithm may include first implementing the enhanced search as a first processing task to obtain a first set of attribute groupings, performing a n-gram blocking between the items in the first set of attribute groupings to obtain a second set of attribute groupings, and performing a sorting neighborhood index on the second set of attribute groupings to obtain a third set of attribute groupings. The third set of attribute groupings may be the final set of attribute groupings.

While step 204 discusses examples of processing tasks performed for the sorting algorithm and an example combination of the processing tasks, additional, fewer, and/or different processing tasks may be performed for the sorting algorithm without departing from the invention. Further, alternative orders of the processing tasks may be performed without departing from the invention.

In step 206, a scoring algorithm is performed on each attribute grouping of the final set of attribute groupings to calculate confidence scores for each pair. In one or more embodiments of the invention, the confidence score is a process for value that measures a strength of confidence that the items in an attribute grouping are identical. For example, a low confidence score may be assigned to attribute groupings where the items are not similar enough to be considered identical. Conversely, a high confidence score may be assigned to attribute groupings where the items are substantially similar.

In one or more embodiments, the scoring algorithm includes performing a classification algorithm on the attributes to determine a confidence score. Examples of classification algorithms include, but are not limited to: logistic regression, decision trees, support vector machines, k-nearest neighbor (KNN) and naive bayes classifier. The classification algorithm may be performed to generate a confidence score for the items in each attribute grouping.

In step 208, a dynamic thresholding is implemented to each confidence score to obtain a set of match grades associated with the confidence scores. In one or more embodiments of the invention, the dynamic thresholding is a process for determining a match-grade threshold to be applied to the confidence score of each attribute grouping based on factors associated with the values of the items of the attribute groupings. For example, the variance in lengths of the values in the attribute groupings may lower the match-grade threshold. In this example, the larger the variance in length between two items may result in a lower match-grade threshold, increasing the chance of determining a high match grade.

In one or more embodiments, a match grade of “A” may be assigned to confidence scores that are above a first match-grade threshold. In one or more embodiments, a match grade of “F” may be assigned for confidence scores below a second match-grade threshold. A match grade of “B” may be assigned for confidence scores between the first and second match grades.

In step 210, a group identifier (ID) is assigned for each attribute in the aggregated database based on the match grades between the pairs in the entry blocks. In one or more embodiments, a group identifier is a unique number assigned on a per-entity basis. In this example, each value in an attribute grouping with a high match grade may be assigned the same group ID. This may be used to indicate that the items in the attribute grouping describe the same entity. Continuing with the example, for an attribute grouping with a low match grade (e.g, the items in the attribute grouping are determined to not correspond to the same entity), each item is assigned a unique grouping ID.

In step 212, a client resolution is performed using any identified matching group IDs. In one or more embodiments of the invention, the client resolution includes identifying relationships between entities based on the collective associations specified in the client information entries. For example, consider a scenario in which a first client information entry specifies item A (e.g., a name) and item B (e.g., an address) both associated with a user. Because items A and B are included in the same client device entry, the items A and B are associated with each other. A second client information entry may specify item C (e.g. the same name as item A) and item D (e.g., a home phone number). Because items A and B are associated with each other, and items A and C are the same entity, the client resolution may include further associating the name (e.g., for items A and/or C) with the home phone number (e.g., for item D). The client resolution may be repeated for each identified entity and the corresponding associations as established by the client information entries.

In step 214, a graph-based attribute report is presented to an administrator of the entity resolution manager. In one or more embodiments of the invention, the graph-based attribute report is a representation of the relationships between the entities identified in FIG. 2 and the associations determined herein. The graph-based attribute report may be displayed, for example, on a computing device using a graphical user interface (GUI). The computing device may be the computing device on which the entity resolution manager executes. Alternatively, the results of the client resolution may be provided to the computing device to enable the computing device to display the graph-based attribute report. The computing device may be operated by an administrator that manages the operation of the entity resolution manager.

### Example

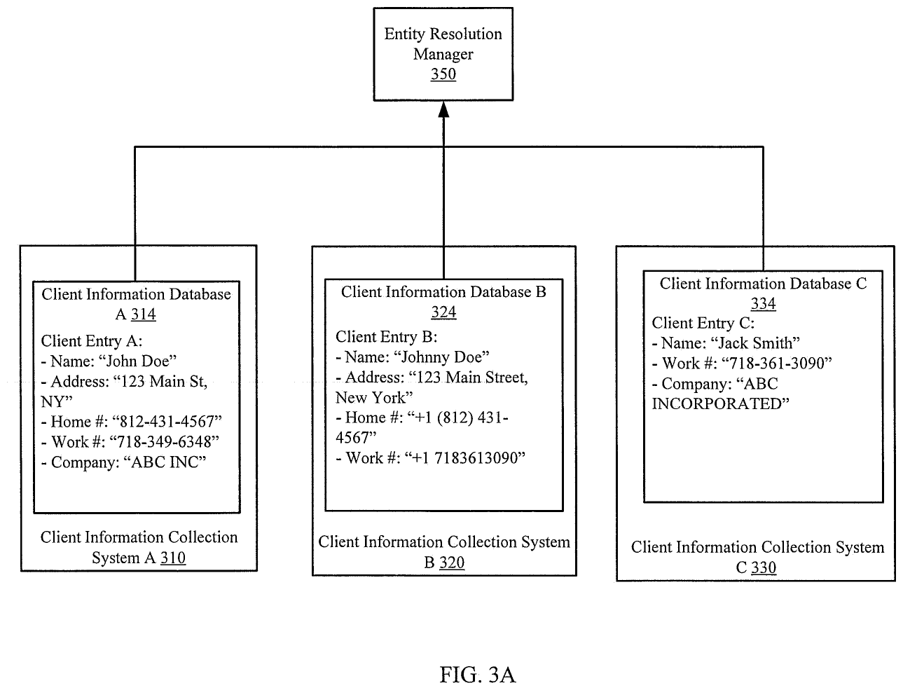

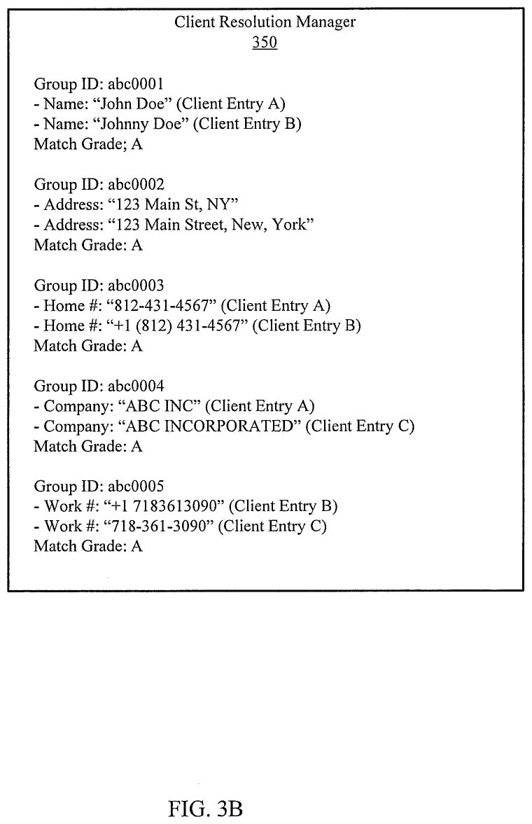

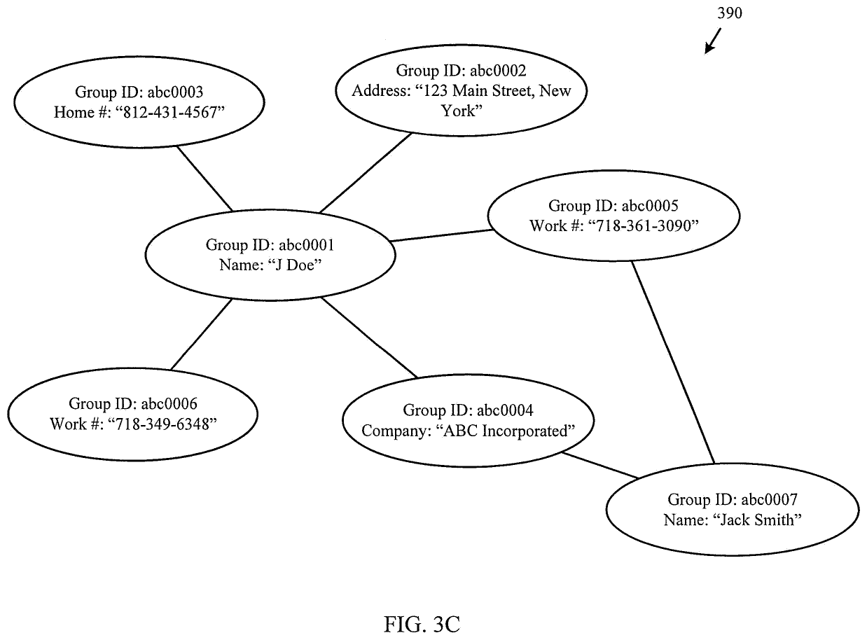

The following section describes an example. The example, illustrated in FIGS. 3A-3C, is not intended to limit the invention and is independent from any other examples discussed in this disclosure. Turning to the example, consider a scenario in which a group of users provide client information to three independent client information collection systems.

FIG. 3A shows a diagram of an example system. For the sake of brevity, not all components of the example system are illustrated in FIG. 3A. The example system includes an entity resolution manager (350) and three client information collection systems (310, 320, 330). The client information systems (310, 320, 330) may each host a client information database (314, 324, 334). Client information collection system A (310) hosts client database A (314) which includes client entry A; Client information collection system B (320) hosts client database B (324) which includes client entry B; Client information collection system C (330) hosts client database C (334) which includes client entry C.

Continuing the example, the entity resolution manager (350) obtains the client entries from the three client information databases (314, 324, 334). The entity resolution manager (350) performs the method of FIG. 2 to perform an entity resolution for the client entries.

Specifically, the entity resolution manager (350) generates an aggregated database that includes client entries A, B, and C from the three client information databases (314, 324, 334). Further, the entity resolution includes performing a sorting algorithm on each attribute (e.g., Name, Address, Home #, Work #, Company) to group the items in each attribute. For example, the name “John Doe” from client entry A is grouped with the name “Johnny Doe” from client entry B to the same attribute grouping. Further, the address item “123 Main St. NY” of client entry A and the address item “123 Main Street, New York” of client entry B are grouped in the same attribute grouping. For the sake of brevity, not all attribute groupings are discussed in this example. Each attribute grouping is generated using the sorting algorithm discussed in FIG. 2.

Using the generated attribute grouping, a confidence score is calculated for each attribute grouping using a classifier algorithm. Based on the generation of the confidence scores, a dynamic threshold is implemented to each attribute grouping to determine the thresholds to be performed based on the variance in lengths between the values in an attribute grouping. In this example, because the two items “123 Main Street, New York” and “123 Main St. NY” have a large variance in length, the threshold to be a high match grade is lower than the two items “John Doe” and “Johnny Doe” as the latter pair have the same number of characters. Based on the lowered threshold, the requirement for the first pair of items to be a high match grade is low. The dynamic threshold is applied to each attribute grouping to generate a match grade for each attribute grouping. Match grade “A” is assigned to each attribute grouping in which the items are highly regarded as associated with the same entity. Match grade “B” is assigned to each attribute grouping in which the items are moderately regarded as associated with the same entity. Match grade “C” is assigned to each attribute grouping in which the items are not regarded as associated with the same entity.

Turning to FIG. 3B, the client resolution manager (350) generates a group ID to each item based on the match grades. FIG. 3B shows the group IDs assigned to those attribute groupings that were assigned a match grade of “A”. For the sake of brevity, not all items are listed in FIG. 3B. Though not shown in FIG. 3B, the items in attribute groupings with a match grade of “B” or “F” are each assigned unique group IDs that are each different from the other items in the aggregated database, including the other items in their respective attribute grouping.

After the group identifiers are generated to distinguish the entities specified in the aggregated database, the entity resolution further includes identifying the relationships between the entities. FIG. 3C shows a diagram of a graph-based relation report. The graph-based relation report (390) displays a relationship between entities (illustrated in circles) and their relationship to other entities as illustrated with a connected line. The relationships are determined based on the client entries shared between the items and the determination that entities specified in different client entries are identical. For example, client entry C specifies “John Smith” as being related to the company “ABC Incorporated”. Client entry A specifies the name “John Doe” as being associated with the company “ABC INC”. The entity resolution determined that the items “ABC INCORPORATED” and “ABC INC” refer to the same company (see, e.g., FIG. 3B). As such, both “Jack Smith” and “Johnny Doe” are related to the entity “ABC Incorporated”. The graph-based relation report (390) may be provided to an administrator (e.g., a user) of the entity resolution manager (350) via a GUI.

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the computing device. Further, such instructions may correspond to computer readable instructions that are stored on one or more non-transitory computer readable mediums.

One or more embodiments of the invention may improve the operation of one or more computing devices. More specifically, embodiments of the invention provide a method for managing the entities that provide information to independent collection systems and aggregating the information to determine duplicate instances of client information. Embodiments improve the user experience by reducing the cognitive burden required by a user to identify attributes and associating them to the same entity by performing the entity resolution described throughout this disclosure. Embodiments of the invention provide uses for the entity resolution that further improve the user experience by tailoring the computing resources based on the knowledge of each user and/or entity.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for entity resolution, the method comprising:
obtaining, by an entity resolution manager, an aggregated database comprising a set of client information entries;
in response to the obtaining:
performing a sorting algorithm on attributes of each client information entry in the aggregated database to obtain a set of attribute groupings;
performing a scoring algorithm on each of the set of attribute groupings to calculate a set of confidence scores each corresponding to a pair of attributes in each set of attribute groupings;
assigning a group identifier (ID) to each item in each of the set of attribute groupings based on the set of confidence scores;
performing a client resolution using the group ID of each item to obtain a graph-based attribute relation report; and
display the graph-based attribute relation report on a graphical user interface (GUI).

2. The method of claim 1, wherein the set of client information entries is obtained from at least two independent client environments.

3. The method of claim 2, further comprising:
performing a client information aggregation using the set of client information entries to obtain the aggregated database.

4. The method of claim 1, wherein performing the sorting algorithm comprises:
performing an elastic search on the attributes of each client information entry to obtain a second set of attribute groupings;
performing a sorted neighborhood indexing on a portion of the attributes to obtain a third set of attribute groupings; and
performing an n-gram blocking on a second portion of the set of client information entries to obtain the set of attribute groupings,
wherein the portion of the attributes comprises the second portion of the attributes.

5. The method of claim 4, wherein performing the scoring algorithm comprises applying a machine learning classifier on the set of the attribute groupings to generate a confidence score for each of the set of attribute groupings.

6. The method of claim 4, further comprising:
implementing a dynamic thresholding to each of the set of attribute groupings to obtain a match grade for each attribute based on the confidence score of each of the third set of attribute groupings.

7. The method of claim 6, wherein the client resolution is generated based on the match grade for each attribute of the third set of attribute groupings.

8. A non-transitory computer readable medium comprising computer readable program code, which when executed by a computer processor enables the computer processor to perform a method for managing a resource system, the method comprising:
obtaining, by an entity resolution manager, an aggregated database comprising a set of client information entries;
in response to the obtaining:
performing a sorting algorithm on attributes of each client information entry in the aggregated database to obtain a set of attribute groupings;
performing a scoring algorithm on each of the set of attribute groupings to calculate a set of confidence scores each corresponding to a pair of attributes in each set of attribute groupings;
assigning a group identifier (ID) to each item in each of the set of attribute groupings based on the set of confidence scores;
performing a client resolution using the group ID of each item to obtain a graph-based attribute relation report; and
display the graph-based attribute relation report on a graphical user interface (GUI).

9. The non-transitory computer readable medium of claim 8, wherein the set of client information entries is obtained from at least two independent client environments.

10. The non-transitory computer readable medium of claim 9, further comprising:
performing a client information aggregation using the set of client information entries to obtain the aggregated database.

11. The non-transitory computer readable medium of claim 8, wherein performing the sorting algorithm comprises:
performing an elastic search on the attributes of each client information entries to obtain a second set of attribute groupings;
performing a sorted neighborhood indexing on a portion of the attributes to obtain a third set of attribute groupings; and
performing an n-gram blocking on a second portion of the set of client information entries to obtain the set of attribute groupings,
wherein the portion of the attributes comprises the second portion of the attributes.

12. The non-transitory computer readable medium of claim 11, wherein performing the scoring algorithm comprises applying a machine learning classifier on the set of the attribute groupings to generate a confidence score for each of the set of attribute groupings.

13. The non-transitory computer readable medium of claim 11, further comprising:
implementing a dynamic thresholding to each of the set of attribute groupings to obtain a match grade for each attribute based on the confidence score of each of the third set of attribute groupings.

14. The non-transitory computer readable medium of claim 13, wherein the client resolution is generated based on the match grade for each attribute of the third set of attribute groupings.

15. A system comprising:
a processor; and
memory comprising instructions, which when executed by the processor, perform a method comprising:
obtaining an aggregated database comprising a set of client information entries;
in response to the obtaining:
performing a sorting algorithm on attributes of each client information entry in the aggregated database to obtain a set of attribute groupings;
performing a scoring algorithm on each of the set of attribute groupings to calculate a set of confidence scores each corresponding to a pair of attributes in each set of attribute groupings;
assigning a group identifier (ID) to each item in each of the set of attribute groupings based on the set of confidence scores;
performing a client resolution using the group ID of each item to obtain a graph-based attribute relation report; and
display the graph-based attribute relation report on a graphical user interface (GUI).

16. The system of claim 15, wherein the set of client information entries is obtained from at least two independent client environments.

17. The system of claim 16, further comprising:
performing a client information aggregation using the set of client information entries to obtain the aggregated database.

18. The system of claim 15, wherein performing the sorting algorithm comprises:
performing an elastic search on the attributes of each client information entries to obtain a second set of attribute groupings;
performing a sorted neighborhood indexing on a portion of the attributes to obtain a third set of attribute groupings; and
performing an n-gram blocking on a second portion of the set of client information entries to obtain the set of attribute groupings,
wherein the portion of the attributes comprises the second portion of the attributes.

19. The system of claim 18, wherein performing the scoring algorithm comprises applying a machine learning classifier on the set of the attribute groupings to generate a confidence score for each of the set of attribute groupings.

20. The system of claim 18, further comprising:
implementing a dynamic thresholding to each of the set of attribute groupings to obtain a match grade for each attribute based on the confidence score of each of the third set of attribute groupings.
